(19) United States
(12) Patent Application Publication
(10) Pub. No.: US 2008/0112545 A1
(43) Pub. Date: May 15, 2008

(54) METHOD, SYSTEM AND APPARATUS FOR RECORDING VOICE DATA IN HALF-DUPLEX COMMUNICATION

(75) Inventors: Zhibin LI, Guangdong (CN); Hai SHEN, Guangdong (CN); Xiangdi WU, Guangdong (CN); Guangjing CHEN, Guangdong (CN)

Correspondence Address: SUGHRUE MION, PLLC, 2100 PENNSYLVANIA AVENUE, N.W., SUITE 800, WASHINGTON, DC, 20037, US

(73) Assignee: HUAWEI TECHNOLOGIES CO., LTD., Guangdong (CN)

(21) Appl. No.: 11/954,318

(22) Filed: Dec. 12, 2007

Related U.S. Application Data
(63) Continuation of application No. PCT/CN2006/002891, filed on Oct. 27, 2006.

(30) Foreign Application Priority Data
Feb. 6, 2006 (CN) 200610003242.1

(51) Int. Cl. H04M 1/64; G06F 17/30

(52) U.S. Cl. 379/85; 707/3; 707/E17.014

(57) ABSTRACT

Embodiments of the present invention provide a system for recording voice data in a half-duplex communication. The system includes a voice data recording node and a data storing node; the voice data recording node generates a voice data record according to voice data received from a server and managing the data storing node, and the data storing node stores the voice data record. Correspondingly, a function of sending the voice data to the voice data recording node is added in the server. The system further includes an agent gateway. A user or an operator defines a filtering condition, defines an acquiring condition and searches for voice data via the agent gateway, and the filtering condition and the acquiring condition are stored by the voice data recording node. The voice data recording node connects to the agent gateway via an external searching interface and a management interface. Embodiments of the present invention further provide a method and apparatuses for recording voice data by using the above system. In the method, voice data records according to a filtering condition are recorded and the user or the operator may also search for the voice data records.

### FIELD OF THE TECHNOLOGY

The present invention relates to mobile communication technologies, and more particularly, to a method, a system and apparatuses for recording voice data in a half-duplex communication.

### BACKGROUND OF THE INVENTION

A Push to Talk over Cellular (PTT) service is a voice communication service based on half-duplex point-to-point and point-to-multipoint technologies of a mobile network. In the PTT service, a user performs a call with other users or user groups through pressing a key of a terminal; voice and data connections may simultaneously be established during a call; a user is able to define a group and perform a call in the group.

FIG. 1 shows the implementation of PTT service. In a simple illustrative embodiment, a calling terminal A in FIG. 1 calls two called terminals B and C. In practical, the number of the called terminals is determined according to the number of members in a user group and may be from one to any. A PTT server stores user data of the user group. The user data includes access rights, authentication information, preconfigured group qualifications, routes of Session Initial Protocol (SIP) messages etc. Before starting a call, the calling terminal A applies a speech right from the PTT server via a wireless network, and the wireless network may be a General Packet Radio Service (GPRS) network or a Universal Mobile Telecommunications System (UMTS) network. After confirming the speech right, the PTT server returns acknowledgement information to the calling terminal A, and notifies the called terminals B and C which are other members in the call. When the call is being performed, voice and data from the calling terminal A are packaged as data packages, and access the PTT server via the wireless network. The PTT server copies the data packages according to an amount of members in the call, and distributes the data packages to each called terminal according to routes of Session Initial Protocol (SIP).

At present, during the implementation of PTT service, the PTT server is only capable of copying data packages of a calling user and distributing the data packages to the called users without saving the data packages. In this way, users are unable to record some important voice data of PTT calls while the voice data may be an important voucher for making a decision sometimes. For operators, it is unable to implement telecommunication supervision for PTT calls by using a PTT service mode without saving call contents.

### SUMMARY OF THE INVENTION

In view of the above, the present invention provides a method for recording voice data in a half-duplex communication, so as to record and search for call contents.

A method for recording voice data in a half-duplex communication includes: acquiring voice data sent from a participant having the right to speak in a call; and generating a voice data record according to the voice data, and storing the voice data record.

The present invention also provides a system for recording voice data in a half-duplex communication, so as to record and search for call contents.

A system for recording voice data in a half-duplex communication includes: a server, for acquiring voice data from a participant having the right to speak in a call; a voice data recording node, for generating a voice data record according to the voice data; and a data storing node, for storing the voice data record.

The present invention also provides a server and an apparatus for recording voice data in a half-duplex communication, so as to record and search for call contents.

A server for recording voice data in a half-duplex communication includes: a first module, for acquiring voice data from a participant having the right to speak in a call; and a second module, for sending the voice data to a voice data recording node to generate a voice data record according to the voice data.

An apparatus for recording voice data in a half-duplex communication includes: a voice data recording node, for acquiring voice data from a participant having the right to speak via a server and generating a voice data record according to the voice data; and a data storing node, for storing the voice data record.

As can be seen from the above technical solution, a server sends voice data from a terminal to a voice data recording node, through interaction between the voice data recording node and the server, and the voice data recording node generates a voice data record. Then, the voice data recording node stores the generated voice data record into a data storing node, so that recording call contents is implemented. By defining a filter condition, important call contents may selectively be recorded, but it is unnecessary to record all call contents, so as to save storage space. In the procedure of searching for voice data, operators and users are able to search for a voice data record through an agent gateway or a terminal. And by defining an acquiring condition of the voice data record, leakages of the call contents is avoided, so as to ensure the security of the voice data records.

### BRIEF DESCRIPTION OF THE DRAWINGS

FIG. 1 is a schematic diagram illustrating a conventional PTT service.

FIG. 2 is a schematic diagram illustrating a system networking in accordance with an embodiment of the present invention.

FIG. 3 is a work flowchart illustrating an operator definition mode in accordance with an embodiment of the present invention.

FIG. 4 is a work flowchart illustrating a user definition mode in accordance with an embodiment of the present invention.

FIG. 5 is a flowchart of searching for a voice data record using an acquiring condition of the voice data record in accordance with an embodiment of the present invention.

### DETAILED DESCRIPTION OF THE INVENTION

The present invention is further described as follows with reference to embodiments and accompanying drawings for a more explicit explanation of the object, technical solution and beneficial effects of the present invention.

For the purpose of implementing a function of recording voice data of a PTT call, a voice data recording node and a data storing node are added in a conventional PTT system. The voice data recording node is mainly capable of managing voice data including: generating voice data records based on received voice data, managing the data storing node, storing filtering conditions of voice data and providing a management interface for externals. The data storing node is mainly capable of storing voice data records. In addition, an agent gateway is further configured as an interface for external interactive, so that the voice data recording node may conveniently provide the management interface and storage function for the externals.

In particular, the voice data recording node is capable of storing a filtering condition of PTT voice data currently recorded (referred to as a filtering condition hereinafter). For example, the filtering condition includes an initiator of a PTT call and a receiver of the PTT call (including a user, a group or an IP address), time period of voice data of the PTT call, participant etc. Here, the participant may be a terminal issuing a voice. The voice data recording node records voice data of PTT calls according to the filtering condition. There are two methods for defining a filtering condition: one is to define the filtering condition by an operator according to requirements; the other is to define the filtering condition by a user through a terminal corresponding to the user. That is, a PTT terminal may be configured to define filtering conditions only for voice data of PTT calls initiated or joined by the user of the PTT terminal, or PTT calls which the user is invited to join by other users. Meanwhile, such voice data records corresponding to the voice data may only be accessed by definers or users designated by the definers.

The voice data recording node is further capable of packaging voice data and related description information corresponding to the voice data to be recorded. Here, the voice data and related description information corresponding to the voice data are sent from a PTT server. The related description information includes identification of a PTT call, a participant, time and a record subscriber corresponding to the voice data etc. And then the voice data recording node outputs the packaged voice data and description information to the voice data storing node. All voice data and related description information of all PTT terminals participating in one PTT call are packaged to generate one voice data record. Since the PTT call is in a half-duplex mode, a PTT terminal is configured to acquire a speech right before starting a PTT call, and therefore voice data of different PTT terminals may be distinguished. Thus, it is possible to record and package all voice data and related description information for each PTT terminal participating in a PTT call to generate a voice data record corresponding to the PTT terminal, respectively, or to package a piece of voice data of a PTT terminal to generate a voice data record. Here, a piece of voice data of the PTT terminal refers to voice data and related description information of the PTT terminal from the time of acquiring a speech right to the time of losing the speech right by the PTT terminal. In this way, the voice data record of all PTT terminals participating in a PTT call can be searched, or the voice data record of a certain PTT terminal participating in the PTT call can be searched, or a certain piece of voice data records of a certain PTT terminal participating in the PTT call can be searched.

In addition, the voice data recording node also provides an external searching interface and a management interface. Through the external searching interface, a user may search the data storing node for a voice data record via a mobile station terminal or via a Web page. The management interface provides a user agent for externals as a uniform entrance for Web users or operators.

The voice data recording node connects to the PTT server through a voice data transmission interface and a signaling transmission interface. Each of the voice data transmission interface and the signaling transmission interface is carried by using an Internet Protocol (IP).

The data storing node is capable of storing voice data records and providing functions for searching voice data and other related data. Due to the large magnitude of voice data of PTT calls, the voice data and other related data are necessary to be encoded; therefore the data storing node may provide encoding processing and decoding processing for the voice data and other related data. The data storing node also provides a data management function. For example, the data storing node presets a storage expire time, and deletes voice data records automatically when the storage time of the voice data records of the PTT calls expires.

The data storing node may be distributed and managed by the voice data recording node.

The agent gateway is capable of providing ways for a user to use the external searching interface and the management interface provided by the voice data recording node, other than via a PTT terminal. For example, the user may use the external searching interface and the management interface via a Web or a Wireless Application Protocol (WAP) terminal to acquire a voice data record or to set a filtering condition of a recorded PTT call etc. The agent gateway, also served as an agent of a manager, provides a function for operators to remotely manage the voice data recording node. The agent gateway may also provide a storage capability interface or an interactive capability interface to services which are located in other networks or use other protocols.

The PTT server may also be changed correspondingly. For example, a voice management module is added in the PTT server. The voice management is configured to provide signaling and data interaction which are related to the voice data recording node. Here, the signaling includes: signaling for acquiring a filtering condition of PTT call voice data, signaling for starting or terminating recording voice data records of the PTT call or signaling for acquiring a voice data record etc. The voice management is also used to send voice data packages according to a filtering condition and adjunct information of the voice data packages to the voice data recording node. Here, the adjunct information includes: an identification of the PTT call, a participant, call time and a subscriber corresponding to the voice data packages. The voice management module may further provide a function of acquiring a voice data record from the voice data recording node according to requirements of users, and the PTT server sends the voice data records to the users.

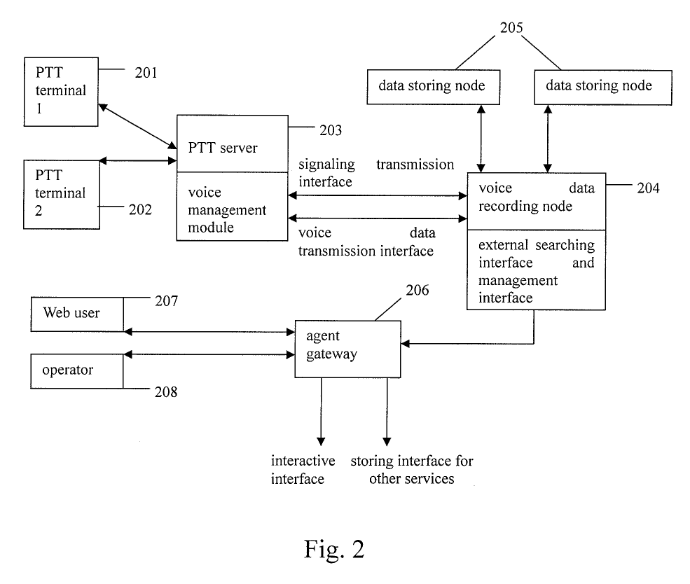

FIG. 2 is a schematic diagram illustrating a networking of a PTT system in accordance with an embodiment of the present invention.

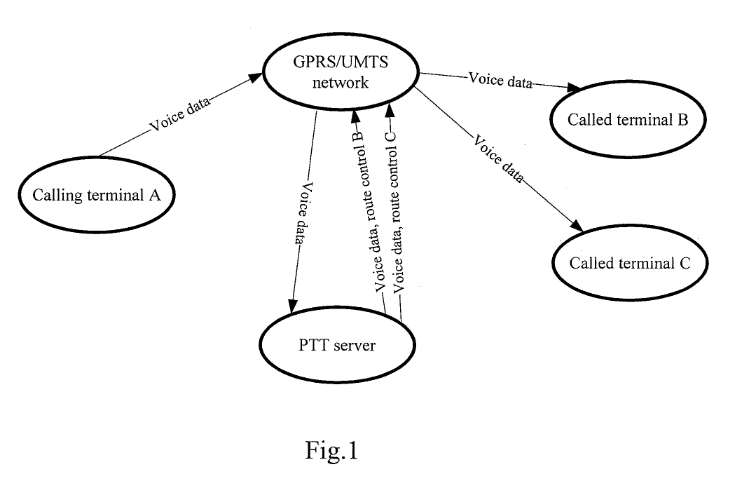

The 201 and 202 are PTT terminals. In a simple illustrative embodiment, the embodiment only provides two PTT terminals herein while there may be multiple PTT terminals in practice. A PTT server 203 includes a voice management module. The connection among the PTT terminal 201, the PTT terminal 202 and the PTT server 203 is similar to that in FIG. 1 and will not be further described herein.

A voice data recording node 204 connects to the voice management module in the PTT server 203 via a signaling transmission interface and a voice data transmission interface; the voice data recording node 204 also connects to multiple data storing nodes 205. In addition, the voice data recording node 204 connects to an agent gateway 206 via an external searching interface and a management interface. A Web user 207 and an operator 208 respectively connect to the agent gateway 206. In addition, the agent gateway 206 may also provide an interactive interface and a storage interface for other services, and provide a storage capability interface or an interactive capability interface to services which are located in other networks or use other protocols.

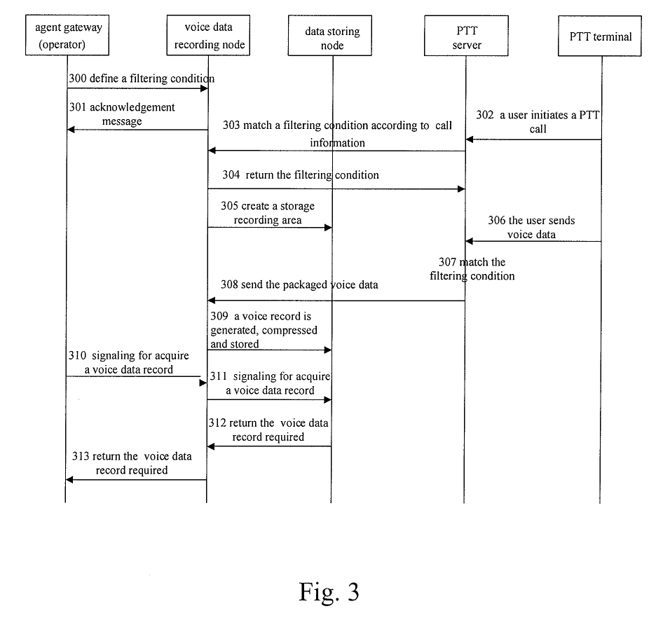

FIG. 3 shows a workflow illustrating a process of defining a filtering condition by an operator in an embodiment of the present invention.

Step 300 and 301: an operator defines a filtering condition of PTT call voice data using an agent gateway via a management interface of a voice data recording node, and then the operator saves the filtering condition into a filtering condition database of the voice data recording node. After the definition is finished, the voice data recording node returns an acknowledgement message to the agent gateway. The above processes are performed once and unnecessary to be performed in every PTT calls.

Step 302: a PTT terminal submits a request of initiating a call to a PTT server.

Step 303 and 304: after receiving the request of initiating the PTT call, the PTT server notifies the voice data recording node of call information of the newly initiated call via a signaling transmission interface. The voice data recording node searches through the filtering condition database according to the call information; if there is a matched filtering condition, the voice data recording node returns a notification message carrying the filtering condition to the PTT server via a signaling transmission interface, so as to notify that voice data of the call is to be recorded.

Step 305: the voice data recording node notifies a data storing node of establishing a storage recording area corresponding to the call.

Steps 306 to 308: the PTT terminal sends voice data to the PTT server. The PTT server selects matched voice data according to the filtering condition while copying and forwarding the voice data. The PTT server packages the matched voice data and sends the packaged voice data to the voice data recording node via a voice data transmission interface.

Step 309: after receiving the voice data of the PTT call, the voice data recording node packages the voice data with the call information to generate a voice data record, and then the voice data recording node sends the voice data record to the data storing node. The data storing node encodes the received voice data record and stores the encoded voice data record to the designated storage recording area.

Steps 310 to 313: when the call is being performed or after the call is finished, the operator searches for a required voice data record by using the agent gateway via an external searching interface provided by the voice data recording node. The voice data recording node acquires decoded voice data record from the data storing node and returns the decoded voice data record to the agent gateway.

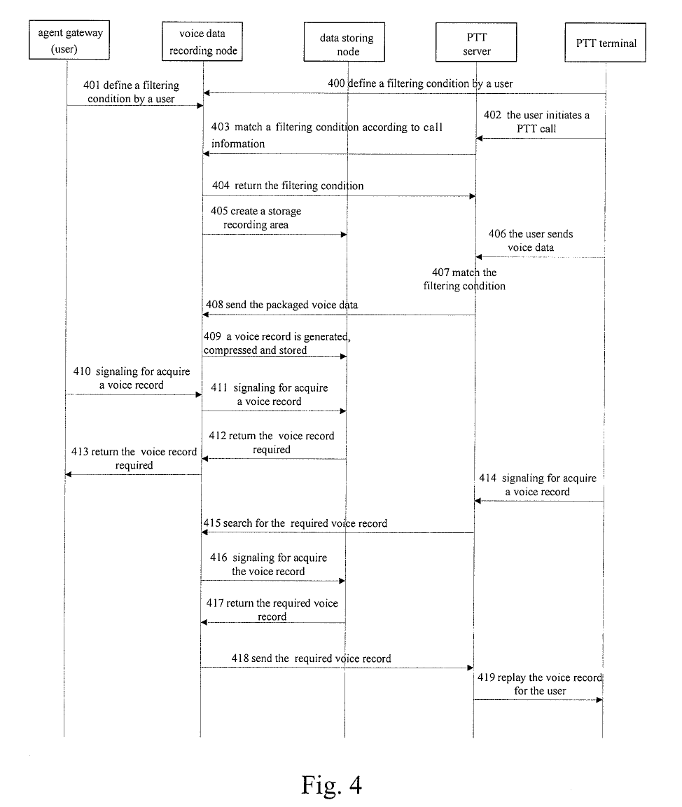

FIG. 4 shows a workflow illustrating a process of defining a filtering condition by a user in an embodiment of the present invention.

Steps 400 and 401: a user defines a filtering condition of voice data by using a PTT terminal or via an agent gateway, and the filtering condition is stored in a filtering condition database of a voice data recording node. When the user defines the filtering condition by using the PTT terminal, the user may directly define the filtering condition via the PTT terminal, or the user may select one of the filtering conditions predefined on the PTT server via the PTT terminal. After the definition is finished, the voice data recording node returns an acknowledgement message to the PTT terminal or the agent gateway. Both of these two steps aim to define the filtering condition. Only one step needs to be selected and performed before a call starts, and the defined filtering condition may be used in subsequent call. It is unnecessary to define the filtering condition before each call.

Step 402: a PTT terminal submits a request of initiating a call to a PTT server. The request includes a demand for recording voice data.

Steps 403 and 404: after receiving the request of initiating the call, the PTT server determines whether there is a demand for recording voice data; if so, the PTT server notifies the voice data recording node of call information of the newly initiated call via a signaling transmission interface. The voice data recording node searches through the filtering condition database according to the call information. If there is a matched filtering condition, the voice data recording node returns a notification message carrying the matched filtering condition to the PTT server via the signaling transmission interface, so as to notify that voice data of the call needs to be recorded, and then subsequent steps are performed. Otherwise, a conventional PTT call procedure is performed.

Step 405: the voice data recording node notifies a data storing node of establishing a storage recording area corresponding to the call.

Steps 406 to 408: the PTT terminal sends voice data to the PTT server. The PTT server selects matched voice data according to the filtering condition while copying and forwarding the voice data, and then the PTT server packages the matched voice data and sends the packaged voice data to the voice data recording node via a voice data transmission interface.

Step 409: after receiving the voice data of the PTT call, the voice data recording node packages the voice data with the call information to generate a voice data record, and then the voice data recording node sends the voice data record to the data storing node. The data storing node encodes the received voice data record and stores the encoded voice data record into the designated storage recording area.

Steps 410 to 413: whenever the call is ongoing or after the call is finished, the user searches for a required voice data record by using the agent gateway via an external searching interface provided by the voice data recording node. The voice data recording node acquires decoded voice data record from the data storing node and returns the decoded voice data record to the agent gateway.

Step 414: when the call is ongoing or after the call is finished, the user may also sends signaling for acquiring a voice data record to the PTT server by using the PTT terminal.

Steps 415 to 417: after receiving the signaling, the PTT server searches the voice data recording node for the required voice data record via an external searching interface. The voice data recording node sends signaling for acquiring a voice data record to the data storing node. After receiving the signaling, the data storing node decodes the required voice data record and sends the decoded voice data record to the voice data recording node.

Steps 418 to 419: the voice data recording node sends the required voice data record to the PTT server, and then the PTT server sends the required voice data record to the PTT terminal.

The filtering condition used in the above procedure may also be defined or changed via the PTT terminal, and the defined or changed filtering condition may be used for filtering voice data after the filtering condition is defined or changed. The request for recording voice data in step 402 may also be sent during the ongoing call, and before the request is sent, the conventional PTT call is ongoing. After receiving the request, the PTT server notifies the voice data recording node, and the procedure for recording voice data is performed. Therefore, the ways of applying the embodiments of the present invention will be more flexible and more applicable to various requirements of users.

In the system of the embodiments of the present invention, except that the definer who defines the filtering conditions can search for the stored voice data records according to the filtering conditions, other users may also search for the stored voice data records. Therefore, an acquiring condition for a voice data record may be predefined, i.e. the acquiring condition is predefined to detect users who are qualified to acquire the voice data record. The acquiring condition may be defined by an operator, or be defined by a user who defines the filtering conditions via the PTT terminal or the agent gateway, and then the acquiring condition is stored in the voice data recording node. The acquiring condition for a voice data record may correspond to a call record of a certain user in a certain call, a call record of a certain time period, a call record of a user within a certain group, or any combination of the above cases.

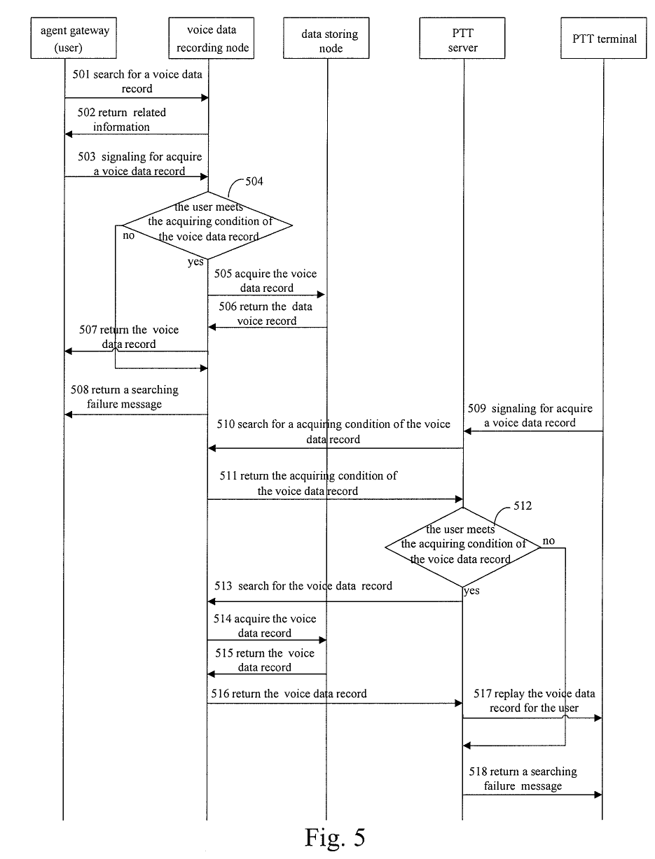

FIG. 5 shows a flowchart of searching for a voice data record in accordance with an embodiment of the present invention. Steps 501 to 508 show a flowchart of searching for a voice data record via an agent gateway by a user. Steps 509 to 518 show a flowchart of searching for a voice data record via a PTT terminal by a user. The above two flows are independent of each other which are described as follows.

Steps 501 to 502: a user sends search signaling to a voice data recording node via an agent gateway. After receiving the signaling, the voice data recording node returns related information of voice data records which can be searched for by the user to the agent gateway.

Step 503: the user sends signaling for acquiring a certain voice data record to the voice data recording node via the agent gateway.

Step 504: the voice data recording node determines whether the user accords with an acquiring condition according to the voice data record; if so, steps 505 to 507 are performed; otherwise, step 508 is performed.

Step 505: the voice data recording node sends a signaling for acquiring the searched-for voice data record to a data storing node.

Steps 506 and 507: after receiving the signaling, the data storing node sends the voice data record to the voice data recording node. Then the voice data recording node sends the voice data record to the agent gateway. And the workflow is terminated.

Step 508: the voice data recording node returns a searching failure message to the agent gateway. And the workflow is terminated.

Step 509: a user sends signaling for acquiring a voice data record to a PTT server via a PTT terminal.

Steps 510 and 511: the PTT server searches for an acquiring condition of the voice data record to be acquired from the voice data recording node. Then the voice data recording node returns the acquiring condition to the PTT server.

Step 512: the PTT server determines whether the user accords with the acquiring condition of the voice data record to be acquired; if so, steps 513 to 517 are performed; otherwise, step 518 is performed.

Steps 513 to 515: the PTT server sends signaling for searching for the voice data record to the voice data recording node. After receiving the signaling, the voice data recording node sends signaling for acquiring the searched-for voice data record to the data storing node. Then the data storing node sends the searched-for voice data record to the voice data recording node.

Steps 516 and 517: the voice data recording node sends the searched-for voice data record to the PTT server, and then the PTT server sends the voice data record to the PTT terminal. And the workflow is terminated.

Step 518: the PTT server returns a searching failure message to the PTT terminal. And the workflow is terminated.

The above steps are basically similar to the flows of searching for the voice data record of the PTT call by the user described in FIGS. 3 and 4, and the main difference is to add a determination for the acquiring condition of the voice data record, i.e. step 504 and step 512. When the search user accords with the acquiring condition, proceed to subsequent steps which are similar to FIGS. 3 and 4. When the search user does not accord with the acquiring condition, the searching failure message is returned to the user.

It should be understood by those skilled in the art that, the system and method provided by the present invention may be used in all half-duplex communication systems including a client and a server. The forgoing description is only described by taking the PTT system for example and is not for use in limiting the protection scope of the present invention to the PTT system.

The foregoing description is only preferred embodiments of the present invention and is not for use in limiting the protection scope thereof. All modifications, equivalent replacements or improvements made within the principles of the present invention should be covered under the protection scope of the present invention.

1. A method for recording voice data in a half-duplex communication, comprising:
acquiring voice data sent from a participant having the right to speak in a call; and
generating a voice data record according to the voice data, and storing the voice data record.

2. The method of claim 1, wherein generating the voice data record according to the voice data comprises:
generating a voice data record including all voice data in the call according to the call of the voice data.

3. The method of claim 1, wherein generating the voice data record according to the voice data comprises:
generating a voice data record including voice data of the participant having the right to speak in the call according to the participant sending the voice data.

4. The method of claim 1, wherein generating the voice data record according to the voice data comprises:
generating a voice data record including voice data of the participant having the right to speak from the time of acquiring the right to speak to the time of losing the right to speak in the call according to the time duration occupied by the participant sending the voice data.

5. The method of claim 1, wherein the voice data is acquired by a server, and the voice data record is generated by a voice data recording node and stored in a data storing node.

6. The method of claim 1, further comprising:
creating a record area on the data storing node; wherein
storing the voice data record comprises: storing the voice data record into the record area.

7. The method of claim 1, further comprising:
acquiring a pre-stored filtering condition corresponding to the call from the voice data recording node; and
sending the voice data according with the filtering condition corresponding to the call to the voice data recording node to generate the voice data record.

8. The method of claim 7, further comprising:
acquiring the filtering condition to be stored in the voice data recording node.

9. The method of claim 8, wherein acquiring the filtering condition comprises:
sending preset filtering conditions on the server; and
receiving a filtering condition selected from the filtering conditions as the filtering condition to be stored in the voice data recording node.

10. The method of claim 7, wherein acquiring the filtering condition corresponding to the call form the voice data recording node comprises:
receiving the voice data recording node of call information;
matching a filtering condition according the call information; and
sending the filtering condition to the server.

11. The method of claim 1, further comprising:
encoding, by the data storing node, the voice data record before storing the voice data record.

12. The method of claim 1, further comprising:
presetting a storage expire time;
deleting, by the data storing node, the voice data record if the storage time of the voice data record expires.

13. A method for searching for voice data in a half-duplex communication, comprising:
acquiring voice data sent from a participant having the right to speak in a call;
generating a voice data record according to the voice data, and storing the voice data record;
receiving a search request for a voice data record from a searcher;
acquiring the voice data record corresponding to the search request; and
returning the voice data record to the searcher.

14. The method of claim 13, wherein the search request is received via an agent gateway, and the voice data record is returned via the agent gateway; or the search request is received via a server, and the voice data record is returned via the server.

15. The method of claim 13, wherein acquiring the voice data record corresponding to the searching request comprise:
acquiring the voice data record corresponding to the searching request if the searcher accords with a pre-stored acquiring condition.

16. The method of claim 13, wherein receiving the search request for the voice data record from a searcher comprises:
sending an acquiring condition corresponding to a search request; and
receiving the search request if the searcher accords with the acquiring condition.

17. A method for searching for voice data in a half-duplex communication, comprising:
sending voice data to a system to generate voice data records;
sending a search request for a voice data record to the system;
receiving a voice data record corresponding to the search request acquired by the system.

18. The method of claim 17, wherein the search request is sent via an agent gateway, and the voice data record is received via the agent gateway; or the search request is sent via a server, and the voice data record is received via the server.

19. The method of claim 17, wherein the voice data record is acquired by the system according to a pre-stored acquiring condition.

20. The method of claim 17, further comprising:
sending a filtering condition to be stored in the system.

21. The method of claim 17, wherein sending a filtering condition to be stored in the system comprises:
receiving preset filtering conditions; and
sending a filtering condition selected from the filtering conditions as the filtering condition to be stored in the system.

22. A system for recording voice data in a half-duplex communication, comprising:
a server, for acquiring voice data from a participant having the right to speak in a call;
a voice data recording node, for generating a voice data record according to the voice data; and
a data storing node, for storing the voice data record.

23. The system of claim 22, wherein
the voice data recording node is further configured to store a filtering condition; and
the server is further configured to acquire a filtering condition corresponding to the call and send voice data according with the filtering condition to the voice data recording node to generate a voice data record.

24. The system of claim 22, wherein
the voice data recording node is further configured to receive via the server a search request for a voice data record from a searcher, acquire the voice data record corresponding to the search request and return the voice data record to the searcher via the server.

25. The system of claim 24, wherein
the voice data recording node is further configured to store a preset acquiring condition of a voice data record; and
the server is further configured to acquire an acquiring condition corresponding to the search request and send the search request to the voice data recording node if the searcher accords with the acquiring condition.

26. The system of claim 22, further comprising:
an agent gateway, for sending a search request for a voice data record received from a searcher to the voice data recording node and returning the voice data record corresponding to the search request received from the voice data recording node to the searcher; wherein
the voice data recording node is further configured to acquire the voice data record corresponding to the search request and return the voice data record to the agent gateway.

27. The system of claim 26, wherein the voice data recording node is further configured to store an acquiring condition of a voice data record and acquire a voice data record corresponding to the search request if the searcher accords with the acquiring condition.

28. The system of claim 22, wherein the participant having the right to speak comprises a Push to Talk over Cellular service terminal, and the server comprises a Push to Talk over Cellular service server.

29. A server for recording voice data in a half-duplex communication, comprising:
a first module, for acquiring voice data from a participant having the right to speak in a call; and
a second module, for sending the voice data to a voice data recording node to generate a voice data record according to the voice data.

30. The server of claim 29, wherein the second module is further configured to filter the voice data according to a filtering condition and send to the voice data recording node if the voice data accords with the filtering condition.

31. The server of claim 29, wherein the second module is further configured to receive a search request for a voice data record from a searcher, send the search request to the voice data recording node, and return a voice data record corresponding to the search request to the searcher.

32. The server of claim 31, wherein the voice management module is further configured to determine whether the searcher accords with a preset acquiring condition corresponding to the search request and send to the voice data recording node the search request if the searcher accords with the preset acquiring condition.

33. An apparatus for recording voice data in a half-duplex communication, comprising:
a voice data recording node, for acquiring voice data from a participant having the right to speak via a server and generating a voice data record according to the voice data; and
a data storing node, for storing the voice data record.

34. The apparatus of claim 33, wherein the voice data recording node is further configured to acquire a voice data record from the data storing node according to a search request received from a searcher and return the voice data record to the searcher.

35. The apparatus of claim 34, wherein the voice data recording node is further configured to determine whether the searcher accords with a preset acquiring condition corresponding to the search request and acquire the voice data record from the data storing node if the searcher accords with the preset acquiring condition.
